(19) United States
(12) Patent Application Publication
(10) Pub. No.: US 2002/0094737 A1
(43) Pub. Date: Jul. 18, 2002

(54) Polyurethane resin composition for synthetic leather and process for making synthetic leather fabrics

(75) Inventor: Jih-Shih Lee, Taichung (TW)

Correspondence Address: LADAS & PARRY, 26 West 61st Street, New York, NY, 10023-7604, US

(73) Assignee: MATURE TRADING CO., LTD.

(21) Appl. No.: 09/861,932

(22) Filed: May 21, 2001

(30) Foreign Application Priority Data
Jan. 17, 2001 (TW) 090101045

(51) Int. Cl. B32B 3/00

(52) U.S. Cl. 442/59

(57) ABSTRACT

A polyurethane resin composition for the production of synthetic leather contains 14 to 20 wt % of polyurethane; 5 to 10 wt % of silicon dioxide; 3 to 8 wt % of a wax material; and 62 to 78 wt % of a solvent.

### BACKGROUND OF THE INVENTION

1. Field of the Invention

This invention relates to a polyurethane resin composition for synthetic leather and to a process for making a synthetic leather fabric.

2. Description of the Related Art

It is known that synthetic leather fabrics are often formed by coating or laminating a substrate, such as woven or nonwoven textile fabric, with a layer of a polymeric layer, such as a polyurethane resin, and subsequently heating and curing the polymeric layer on the substrate. The cured polymeric layer on the substrate is then embossed and is mechanically buffed so as to produce a surface having a natural leather-like appearance. Various polymeric layers for the production of the synthetic leather fabrics have been disclosed in the prior art to provide the desired appearance and other properties, such as durability and softness.

### SUMMARY OF THE INVENTION

It is an object of the present invention to provide a polyurethane resin composition for the production of a synthetic leather that closely resembles natural leather in appearance.

It is another object of the present invention to provide a polyurethane resin-based synthetic leather that closely resembles natural leather in appearance.

It is yet another object of the present invention to provide a process for making the aforesaid polyurethane resin-based synthetic leather fabric.

According to one aspect of the present invention, a polyurethane resin composition comprises: 14 to 20 wt % of polyurethane; 5 to 10 wt % of silicon dioxide; 3 to 8 wt % of a wax material; and 62 to 78 wt % of a solvent.

According to another aspect of the present invention, a polyurethane resin-based synthetic leather fabric comprises: a fabric sheet coated with a polymeric layer; and a polyurethane resin layer coated over and bonded to the polymeric layer on the fabric sheet. The polyurethane resin layer is formed by coating the polymeric layer with a polyurethane resin solution film, which has a composition containing 14 to 20 wt % of polyurethane, 5 to 10 wt % of silicon dioxide, 3 to 8 wt % of a wax material, and 62 to 78 wt % of a solvent, and heating and curing the polyurethane resin solution film to remove the solvent and to form the polyurethane resin layer.

According to yet another aspect of the present invention, a process for making a polyurethane resin-based synthetic leather fabric comprises the steps of: preparing a fabric sheet; coating the fabric sheet with a polymeric layer; preparing a polyurethane resin solution that has a composition containing polyurethane, silicon dioxide, a wax material, and a solvent containing dimethylformamide, methylethylketone, and toluene; coating the fabric sheet with the polyurethane resin solution so as to form a polyurethane resin solution film on the polymeric layer; and heating and curing the polyurethane resin solution film on the polymeric layer to remove the solvent and to form a cured polyurethane resin layer on the polymeric layer.

### BRIEF DESCRIPTION OF THE DRAWINGS

In drawings which illustrate an embodiment of the invention,

FIG. 1 is a block diagram illustrating consecutive steps of a process for making a polyurethane resin-based synthetic leather fabric embodying this invention;

FIG. 2 is a fragmentary cross-sectional side view of the polyurethane resin-based synthetic leather fabric according to the process of this invention;

FIG. 3 is a perspective view to illustrate the polyurethane resin-based synthetic leather fabric being polished by a polishing tool according to the process of this invention; and

FIG. 4 is a schematic view to illustrate several darkened areas on an outer surface of the polyurethane resin-based synthetic leather fabric that resulted from the polishing step in FIG. 3.

### DETAILED DESCRIPTION OF THE PREFERRED EMBODIMENT

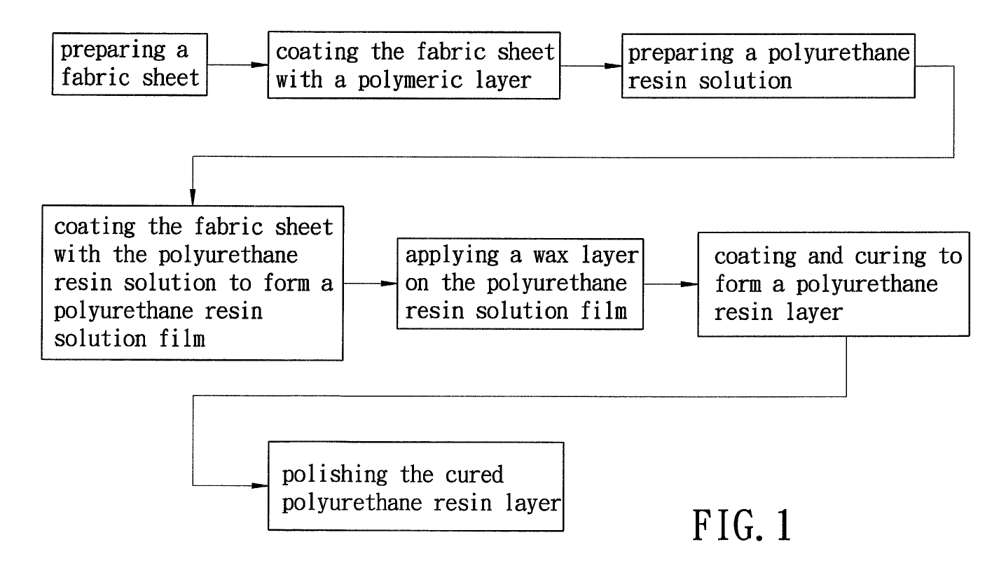

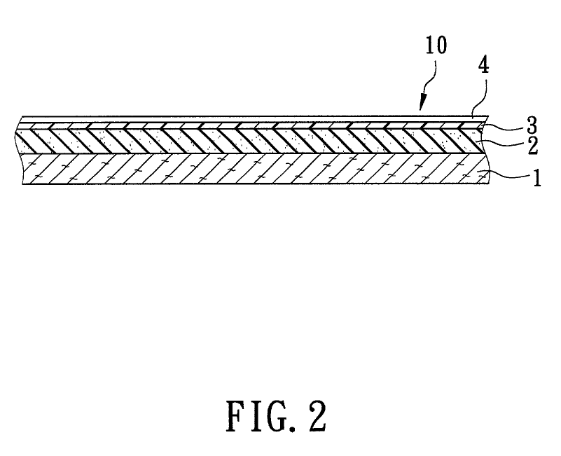

FIGS. 1 and 2 illustrate consecutive steps of a process for making a polyurethane resin-based synthetic leather fabric 10 embodying this invention. The process includes the steps of: preparing a fabric sheet 1 that can be made from a woven or nonwoven textile material; coating the fabric sheet 1 with a polymeric layer 2 by impregnating the fabric sheet 1 with a polymeric solution, such as a foamable polyurethane solution; preparing a polyurethane resin solution that has a composition containing polyurethane, silicon dioxide, a wax material, a dye material (optional), and a solvent containing dimethylformamide, methyl ethyl ketone, and toluene; coating the fabric sheet 1 with the polyurethane resin solution so as to form a polyurethane resin solution film on the polymeric layer 2 on the fabric sheet 1; applying a wax layer 4 on the polyurethane resin solution film; and heating and curing the polyurethane resin solution film on the fabric sheet 1 to remove the solvent and to form a cured polyurethane resin layer 3 that is bonded to the polymeric layer 2 on the fabric sheet 1.

The polyurethane resin layer 3 on the fabric sheet 1 can be patterned, before the aforesaid step of heating and curing, by applying the polyurethane resin solution to a releasable paper which has been formed with a pattern, such as a pattern of a snakeskin, a cow skin, or a crocodile skin, heating and partly curing the polyurethane resin solution on the releasable paper to form a patterned polyurethane resin layer 3, attaching the releasable paper with the patterned polyurethane resin layer 3 to the fabric sheet 1 in a manner that the patterned polyurethane resin layer 3 is bonded to the polymeric layer 2 on the fabric sheet 1, and removing the releasable paper from the patterned polyurethane resin layer 3. An alternative approach to form a pattern on the polyurethane resin layer 3 on the fabric sheet 1 can include the steps of embossing the polymeric layer 2 on the fabric sheet 1 via a printing device and subsequently applying the polyurethane resin solution on the embossed polymeric layer 2 before the aforesaid step of heating and curing. Assembly of the fabric sheet 1 and the polymeric layer 2 can be substituted by a plastic sheet made from polyvinyl chloride.

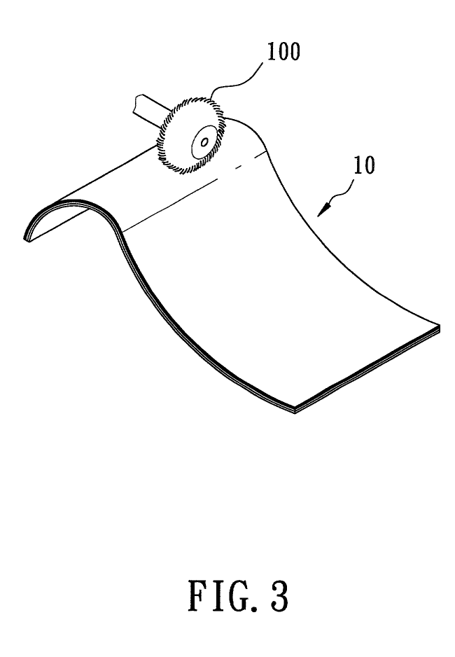

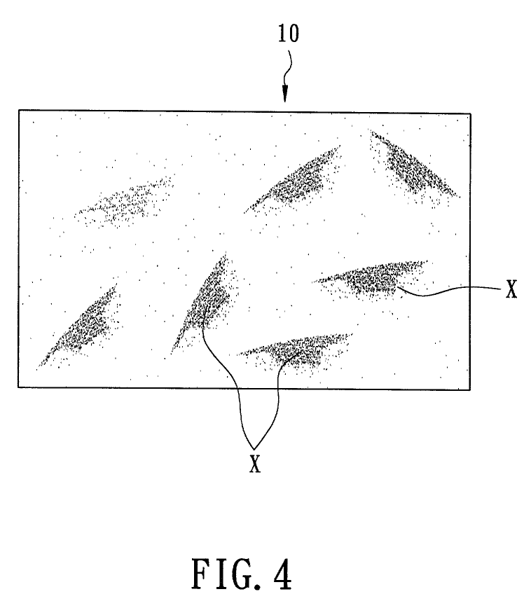

The thus-formed polyurethane resin-based synthetic leather fabric 10 not only closely resembles natural leather in appearance, but also provides a new feature in that when buffed or polished by a polishing tool 100 (see FIG. 3), the color of the surface of the polyurethane resin-based synthetic leather fabric 10 becomes darker. As illustrated in FIG. 4, the shaded regions (X) represent areas on the surface of the polyurethane resin-based synthetic leather fabric 10 that were buffed or polished. With such feature, the appearance of the polyurethane resin-based synthetic leather fabric 10 can be enhanced.

The composition of the polyurethane resin material prepared according to the process of this invention preferably contains 14 to 20 wt % of polyurethane, 5 to 10 wt % of silicon dioxide, 3 to 8 wt % of a wax material, and 62 to 78 wt % of the solvent.

With the invention thus explained, it is apparent that various modifications and variations can be made without departing from the spirit of the present invention. It is therefore intended that the invention be limited only as recited in the appended claims.

I claim:

1. A polyurethane resin composition for the production of synthetic leather, said composition comprising:
14 to 20 wt % of polyurethane;
5 to 10 wt % of silicon dioxide;
3 to 8 wt % of a wax material; and
62 to 78 wt % of a solvent.

2. The composition of claim 1, wherein said solvent contains dimethylformamide, methyl ethyl ketone, and toluene.

3. A polyurethane resin-based synthetic leather fabric, comprising:
a fabric sheet coated with a polymeric layer; and
a polyurethane resin layer coated over and bonded to said polymeric layer on said fabric sheet, said polyurethane resin layer being formed by coating said polymeric layer with a polyurethane resin solution film, which has a composition containing 14 to 20 wt % of polyurethane, 5 to 10 wt % of silicon dioxide, 3 to 8 wt % of a wax material, and 62 to 78 wt % of a solvent, and heating and curing said polyurethane resin solution film to remove said solvent and to form said polyurethane resin layer.

4. The polyurethane resin-based synthetic leather fabric of claim 3, wherein said polymeric layer is made from a foamable polyurethane-based resin.

5. The polyurethane resin-based synthetic leather fabric of claim 3, wherein said solvent contains dimethylformamide, methyl ethyl ketone, and toluene.

6. A process for making a polyurethane resin-based synthetic leather fabric, comprising the steps of:
preparing a fabric sheet;
coating said fabric sheet with a polymeric layer;
preparing a polyurethane resin solution that has a composition containing polyurethane, silicon dioxide, a wax material, and a solvent containing dimethylformamide, methylethylketone, and toluene;
coating said fabric sheet with said polyurethane resin solution so as to form a polyurethane resin solution film on said polymeric layer; and
heating and curing said polyurethane resin solution film on said polymeric layer to remove said solvent and to form a cured polyurethane resin layer on said polymeric layer.

7. The process of claim 6, further comprising a step of applying a wax layer on said polyurethane resin solution film before the step of heating and curing said polyurethane resin solution film.

8. The process of claim 7, further comprising a step of polishing said cured polyurethane resin layer.
